(19) United States
(12) Patent Application Publication
(10) Pub. No.: US 2025/0277147 A1
(43) Pub. Date: Sep. 4, 2025

(54) X-RAY SCINTILLATOR

(71) Applicant: Quantum Advanced Solutions Ltd., Chilworth, Southampton (GB)

(72) Inventors: Marat Lutfullin, Oxford (GB); Lutfan Sinatra, Oxford (GB)

(21) Appl. No.: 18/858,761

(22) PCT Filed: May 1, 2023
(86) PCT No.: PCT/GB2023/051154

§ 371 Date: Oct. 22, 2024

(30) Foreign Application Priority Data
May 6, 2022 (GB) 2206694.8
Jun. 9, 2022 (GB) 2208442.0

(51) Int. Cl. C09K 11/62; G01T 1/20; G01T 1/202

(52) U.S. Cl. CPC C09K 11/628; G01T 1/2002; G01T 1/2018; G01T 1/2023

(57) ABSTRACT

An X-ray scintillator may comprise a planar film having a structured pattern of pores extending perpendicularly to the plane of the film, the pores being filled with nano/micro-crystals to provide X-ray scintillation. In some implementations, each pore is filled with a single microcrystal of X-ray scintillator material. The structured pattern of pores may act as a form of collimator for the light produced by the X-ray scintillation material (the nano/micro-crystals) to help improve resolution of an X-ray imaging system which uses such an X-ray scintillator.

### FIELD

The present application relates to an X-ray scintillator, to devices and systems incorporating such a scintillator, and to methods of making such an X-ray scintillator.

### BACKGROUND

X-ray imaging is used in a number of different contexts, including various forms of medical imaging and security screening at airports. Compared with visible light, X-rays have a short wavelength and correspondingly high energy, and are therefore able to penetrate much more deeply into matter, for example, to reveal the internal contents or structure of a suitcase, a human body, and so on. However, the higher energy of X-rays means that detection devices used for visible light are generally not suitable for the direct detection of X-rays.

One known form of X-ray imaging device includes an X-ray scintillation detector. Such a detector has two main components. The first component is an X-ray scintillator (or scintillator material), which absorbs X-rays and in response outputs (visible) light. In physical terms, the absorption of an X-ray photon places the X-ray scintillator material in an excited state, which then emits one or more photons, e.g. optical photons, to decay back down from the excited state. The second main component of the X-ray scintillation detector is an optical transducer (detector) which absorbs and converts the light emitted by the X-ray scintillator into an electronic signal for output and analysis. As X-ray photons strike different locations of the X-ray scintillator, the (approximate) location of each strike is captured by the optical detector, which is therefore broadly analogous to a form of digital camera. Further background information about X-ray scintillators can be found, inter alia, in “X-Ray Detector Characterization—a comparison of scintillators”, by Jakob Larsson, Master of Science Thesis, KTH-Royal Institute of Technology, Sweden, June 2013 (available from https://www.diva-portal.org/smash/get/diva2: 634109/FULLTEXT01.pdf).

Although various types of X-ray scintillation detector are known, there is ongoing interest in trying to improve the performance of such devices, for example in terms of sensitivity to incoming X-rays, improved spatial resolution, and so on.

### SUMMARY

The invention is defined in the appended independent and dependent claims.

As disclosed herein, an X-ray scintillator may comprise dope halide perovskite nano/micro-crystals. The doped halide perovskite nano/micro-crystals may be lead-free. The X-ray scintillator may be in the form of a flexible polymer film. The X-ray scintillator may be used in many different types of X-ray imaging, including X-ray imaging which exploits the flexibility of the X-ray scintillator. The X-ray scintillator may include a patterned structure of pores which may be filed with the doped halide perovskite nano/micro-crystals. The patterned structure acts as a form of collimator for the light produced by the doped halide perovskite nano/micro-crystals to help improve resolution of an X-ray imaging system which uses such an X-ray scintillator.

As disclosed herein, an X-ray scintillator may comprise a planar film having a structured pattern of pores extending perpendicularly to the plane of the film, the pores being filled with nano/micro-crystals to provide X-ray scintillation. In some implementations, each pore is filled with a single microcrystal of X-ray scintillator material. The structured pattern of pores may act as a form of collimator for the light produced by the X-ray scintillation material (the nano/micro-crystals) to help improve resolution of an X-ray imaging system which uses such an X-ray scintillator.

### BRIEF DESCRIPTION OF THE FIGURES

Various implementations of the claimed invention will now be described by way of example only with reference to the following drawings.

FIG. 1 is a schematic diagram of one example of an X-ray imaging device in accordance with the present disclosure.

FIG. 2 is a schematic diagram of one example of an X-ray scintillation detector that may be used in an X-ray imaging device such as shown in FIG. 1 in accordance with the present disclosure.

FIG. 3 is a schematic diagram of one example of an X-ray scintillator for use in an X-ray scintillation detector such as shown in FIG. 2 as part of an X-ray imaging device such as shown in FIG. 1 in accordance with the present disclosure.

FIG. 4 is a schematic diagram of one example of the use of a flexible X-ray scintillator in an X-ray imaging device in accordance with the present disclosure.

FIG. 5 is a schematic diagram of another example of an X-ray scintillator which is a variation of the X-ray scintillator of FIG. 3, and which again is for use in an X-ray scintillation detector such as shown in FIG. 2 as part of an X-ray imaging device such as shown in FIG. 1 in accordance with the present disclosure.

FIG. 6 shows two images obtained using transmission electron microscopy (TEM) showing the detailed structure of an example of an X-ray scintillator in accordance with the present disclosure, wherein the top image is for an X-ray scintillator including undoped perovskite and the bottom image is for an X-ray scintillator including doped perovskite.

FIG. 7 shows X-ray diffraction (XRD) plots obtained from an example of an X-ray scintillator in accordance with the present disclosure, wherein the top image is for undoped perovskite and the bottom image is for doped perovskite.

FIG. 8 shows two plots obtained from exciting an example of an X-ray scintillator in accordance with the present disclosure. The top plot shows the variation in light output with respect to the wavelength of the excitation light, and the bottom plot shows the variation with wavelength of photoluminescent light emission in response to the excitation light.

FIG. 9 shows two images (photographs) of an example of an X-ray scintillator in accordance with the present disclosure. In the top image, the X-ray scintillator is shown substantially flat, while in the bottom image, the X-ray scintillator is shown in a curved configuration.

FIG. 10 shows two X-ray images of a target which designed to measure spatial resolution of the X-ay imaging process. In the bottom image, the X-ray scintillator used to acquire the image is an example of an undoped halide perovskite in accordance with the present disclosure, while the top image was acquired using a gadolinium oxysulfide (Gadox) X-ray scintillator.

FIG. 11 comprises three images, one depicting microcrystals and the other two depicting a structure having pores (such as illustrated in FIG. 5) for holding the microcrystals.

FIGS. 12 and 13 provide experimental data illustrating the spatial resolution of an X-ray scintillator film comprising Cs₃Cu₂I₅ microcrystals provided with a dopant in accordance with the present disclosure. The example of FIG. 12 is based on a film having a thickness of 100 μm while the example of FIG. 13 is based on a film having a thickness of 200 μm.

### DETAILED DESCRIPTION

Scintillators such as disclosed herein are generally capable of converting ionizing radiation (e.g. X-rays) into light photons for subsequent detection by photodiodes or some other form of optical transducer(s). X-rays typically have a wavelength in the range 0.01-10 nm corresponding to an energy in the range 0.1-100 keV (kilo-electron volts). As used herein, the term X-ray should be considered as extending above 100 keV (e.g. to 1 MeV and beyond) to encompass what are generally considered to be gamma rays, since scintillators such as described herein may also be operational at these higher energies (for example, a known scintillator material such as caesium iodide may be used for both X-ray and gamma ray detection).

Visible light, i.e. light that can be detected by the human eye, is typically in the range 380-750 nm. However, since X-ray scintillation devices generally perform electronic detection of the light output from the scintillator material, this specific range of visible light has no direct relevance. Accordingly, reference to light herein should be understood to include visible light, but also to extend more broadly, for example into the near-infrared, having regard to the sensitivity range of devices that are generally used to detect such electromagnetic radiation in the visible or neighbouring regions of the electromagnetic spectrum.

X-ray scintillators represent important tools for the monitoring and inspection of various engineering devices or structures, for example, pipelines, aeroplanes, nuclear power stations, and so on. For example, an X-ray imaging device including an X-ray scintillator may be used to allow a visual detection of cracks or other warnings of potential failure. Such scintillators are also utilised in many other areas of technology, for example for security X ray imaging (e.g. in airports), for nuclear cameras, and for computed tomography imaging (CTI) and other forms of medical imaging in hospitals, etc.

As described herein, an X-ray scintillator may be formed (inter alia) using halide perovskite particles (material). Such perovskite particles may be available in crystals of various sizes. In the present case, the term nanocrystals is used to denote crystals with a size in the range 1-1000 nanometers (nm), and the term microcrystals is used to denote crystals with a size in the range 1-1000 microns (μm). Furthermore, the term “nano/micro-crystal” will be used to denote a crystal with a size in the range of 1 nm to 1000 μm, i.e. encompassing both nanocrystals and microcrystals, and the term “nano/micro-crystals” represents a plurality of nanocrystals and/or microcrystals. The size of a crystal is generally specified herein to denote the longest dimension of the crystal.

Perovskite nano/micro-crystals can be used to provide an efficient X-ray scintillation material which exhibits strong luminescence under X-ray illumination. Such scintillators typically produce output in the optical window; this output is detectable using (for example) conventional optical transducer devices such as a silicon imaging camera, a photomultiplier tube (PMT) detector, silicon photodiodes or photomultipliers, CMOS image sensors, etc.

The use of X-rays scintillators based on perovskite nano/micro-crystals has been found to provide a number of benefits as discussed below which render this type of X-ray scintillator material especially suitable for a wide range of applications, including inspection, failure/crack detection, security X-ray imaging, nuclear cameras, and computed tomography. Some of these benefits are identified in the listing below. For some entries in this listing, a performance characteristic of an X-ray scintillator based on (doped) halide perovskite nano/micro-crystals (such as described in more detail below) is compared to values obtained using a well-known conventional X-ray scintillator material, namely thallium-activated caesium iodide (CsI:TI), which is normally provided in a macroscopic crystalline, columnar form, and/or Gadox (gadolinium oxysulfide, GdOS), which is usually doped with terbium and is typically prepared as microcrystals.

Some benefits of using an X-ray scintillator based on (doped) halide perovskite nano/micro-crystals include:
a short decay time, typically around 50 ns or less (for X-ray photons of energy up to around 660 keV). In contrast, CsI:TI has a decay time of the order of =1 μs. The decay time represents the duration of the optical light output (e.g. pulse) produced by an incident X-ray photon. Having a shorter decay time supports the imaging of time-varying phenomena at higher temporal resolution, as well as imaging techniques based on scanning which may be of particular value in medical radiography and industrial inspection. A short decay time also helps to prevent saturation arising from a high incoming flux of X-ray photons, which in turn enhances the linearity and dynamic range of the X-ray scintillator (and associated detector).
high sensitivity (from 13 nGy/s, where nGy is an SI unit of absorbed dosage, nanoGrays).
high light output-perovskite nano/micro-crystals as described herein have been found to provide a light output which is comparable with the level produced by CsI:TI as per the following table (Table 1):

TABLE 1

| X-ray energy: | | | | |
|---|---|---|---|---|
| 60 keV (input) | Undoped | Doped | Csl (TI) | Gadox |
| Light Output | 636 | 5350 | 5100 | 10400 |
| (ADU) | | | | |
| Brightness | 6.1% | 51.4% | 49.0% | 100.0% |
| relative to Gadox | | | | |

The table shows experimental results relating to the light output from four different X-ray scintillator materials in response to exposure to X-rays having an energy of 60 keV (kilo electron volts). The output is specified in ADU (analog to digital units)—in effect a linear scale which is not directly calibrated in terms of absolute (SI) units of light intensity, but does allow comparison between the different X-ray scintillator materials. The first two columns of test results are for a halide perovskite material as disclosed herein (namely Cs₃Cu₂I₅), the first column being without any doping of the halide perovskite material, the second column being with doping of the halide perovskite material by thallium (TI) at a level of approximately 10%. The third column presents test results for a standard existing scintillator material made of thallium activated caesium iodide (as mentioned above). The fourth (final) column presents tests results for another standard existing scintillator material, namely Gadox (again as mentioned above).

It can be seen from the above table that doping the halide perovskite provides a very significant enhancement to the light output from the scintillator material (compared to the same scintillator material without doping). As a result, the light output from the doped halide perovskite material is comparable with industry standard materials such as caesium iodide and Gadox (slightly better than caesium iodide, but not as good as Gadox for this particular test).
light output-tunable typically across the range of 410-685 nm, depending on the particular perovskite material, dopant, and so on. In contrast, CsI:TI generally has a fixed peak of emission at around 550 nm. The ability to tune the frequency of the light output from the X-ray scintillator allows the frequency of the light output to be aligned with the maximum sensitivity of the optical transducer, thereby helping to improve overall sensitivity.
the ability to make a flexible scintillator, as discussed in more detail below.
the ability to produce the X-ray scintillator by solution processing in a patterned structure, as discussed in more detail below.

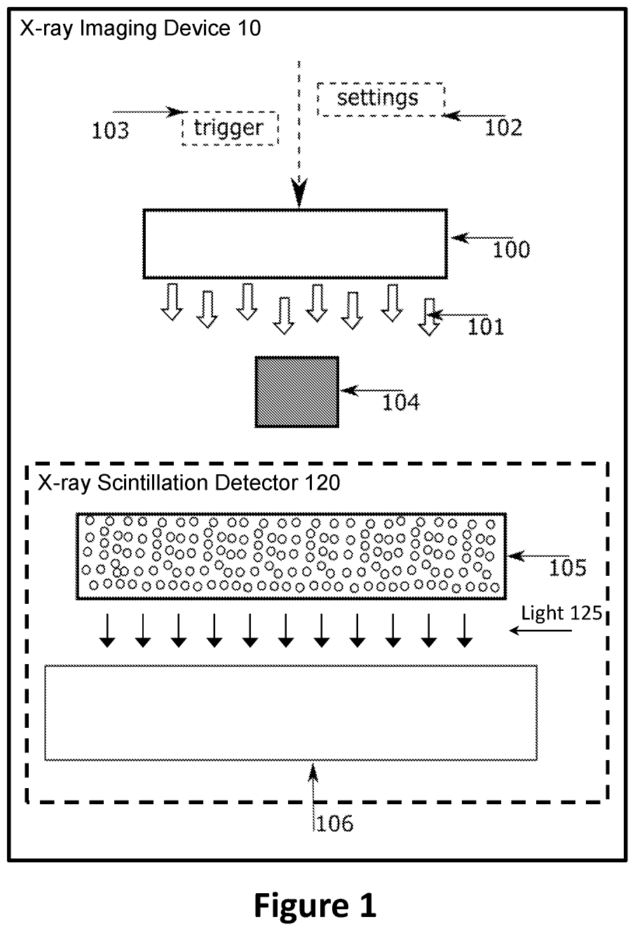

FIG. 1 is a schematic diagram of one example of an X-ray imaging device 10 in accordance with the present disclosure which is configured to image a target 104 of interest. The X-ray imaging device 10 includes an X-ray source 100, such as an accelerated electron beam that impacts on a metal which causes the metal to emit X-rays 101. The X-ray source may be controlled by one or more inputs, such as a trigger 103 and one or more settings 102. The trigger 103 may be utilised to take (initiate) an X-ray exposure captured by the X-ray imaging device 10. The settings 102 may be used to control various aspects of the X-ray exposure, such as the intensity of the emitted X-rays 101, the duration of the X-ray exposure and/or the energy distribution of the emitted X-rays 101 (which may be controlled by the voltage used to accelerate the electron beam).

The settings 102 may also be used to control further aspects of the X-ray imaging device 10, such as configuring the system to take a single exposure or a sequence of exposures. There may be various motivations for obtaining a sequence of exposures, including to obtain a time-resolved image sequence (akin to a video) if the target 104 may exhibit temporal behaviour of interest, or to allow the target 104 to be scanned by the X-ray imaging device 10 (typically to acquire a sequence of images corresponding to different parts of the target). Such scanning may be performed by moving the X-ray imaging device 10 and/or the target 104, thereby generating relative movement between the X-ray imaging device 10 and the target 104. This movement may be translational, such as to scan across a large target, and/or rotational, such as to image the target at different angles. In some implementations, the scanning may be utilised to construct a three-dimensional (volumetric) image of the target, as for computed tomography imaging.

The skilled person will be aware of many additions or alterations to the X-ray imaging device 10 according to different implementations. For example, the relative movement between the X-ray imaging device 10 and the target 104 might also be used to control the separation between the X-ray imaging device 10 and the target 104, such as to adjust the field of view. As another example, the trigger signal 103 may be used to control the duration of the X-ray exposure, rather than this being one of the settings 102—e.g. a first activation of the trigger signal 103 might be used to begin the exposure and a second activation of the trigger signal 103 might be used to end the exposure. Another possibility is that the X-ray exposure might remain open (active) for as long at the trigger signal 103 is activated. Accordingly, the trigger signal 103 and settings 102 are examples of input control signals for the X-ray imaging system 10, and many other ways of controlling the X-ray imaging device 10 will be apparent to the skilled person.

In addition to the X-ray source 100, the X-ray imaging device 10 further includes an X-ray scintillation detection device 120, which comprises an X-ray scintillator 105 and an optical transducer/detector 106. The X-ray scintillator 105 absorbs X-rays 101 that are incident on the X-ray scintillator 105. Inside the X-ray scintillator 105, the X-rays 101 are converted to (optical) light 125, and this light is then emitted by the X-ray scintillator 105 to the optical transducer or detector 106. The optical transducer/detector 106 converts the incident optical light into an electrical (electronic) signal and may be any suitable type of photodetector or electronic imaging device, such as a charged coupled device (CCD), a complementary metal oxide semiconductor (CMOS) sensor, a digital camera, and so on.

The X-ray imaging device 10 is typically used to obtain two-dimensional (2D) or three-dimensional (3D) imaging of the target 104. The target may be any object to be investigated or viewed by X-ray imaging. For example, the target may be a person or a part of a person, e.g. for security or medical imaging, a mechanical object such as a machinery part, a container or a wheel, e.g. for security or for fault prediction and/or diagnosis, and so on.

It will be appreciated that for imaging purposes, a conventional optical camera or similar device has a glass lens which is shaped to focus the image on the detector plane. The use of such a lens is not feasible with X-rays, but other focussing systems may be employed. Such a focussing system (not shown in FIG. 1) might be interposed between the target 104 and the X-ray scintillator 105. In some implementations, a focussing system may comprise a set of nested mirrors each providing a glancing angle of incidence to focus the X-rays onto the detector plane (the X-ray scintillation material 105). Another possibility is to use a pinhole aperture as a focussing system. Another known focussing system is a coded aperture mask, which acts in effect as a pattern of multiple pinholes. When using a coded aperture mask, the X-ray image is derived using a deconvolution procedure based on the image signal received by the X-ray scintillation detector 120 and the known pinhole pattern of the coded aperture mask.

In many implementations, the X-ray imaging device 10 is configured to produce a collimated (parallel) beam of X-rays 101 from the X-ray source 100. In some cases, when the beam has a relatively narrow cross-section compared to the target, the beam might be scanned across the target 104, thereby obtaining a succession of X-ray images for different portions of the target 104. This scanning may be performed by using any appropriate technique or method to generate relative movement between the target 104 and the X-ray source 100.

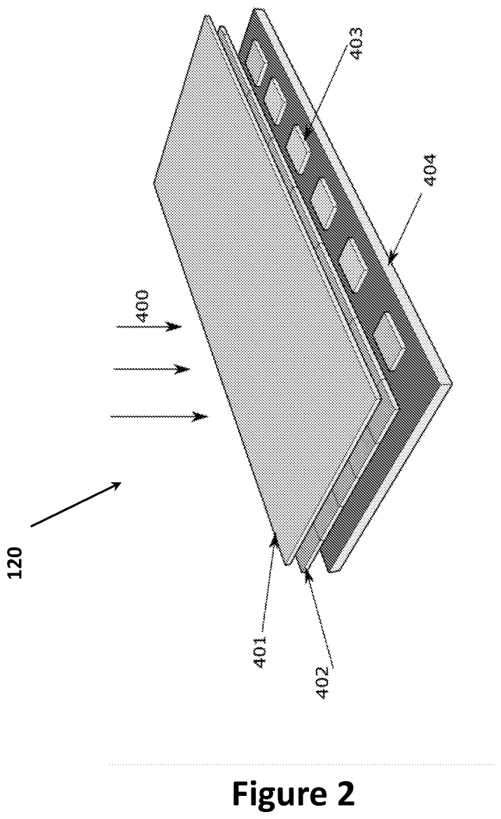

FIG. 2 is a schematic diagram of one example of an X-ray scintillation detector (device) 120 that may be used in an X-ray imaging device 10 such as shown in FIG. 1 in accordance with the present disclosure. The X-ray scintillation detector 120 receives X-ray radiation 400 which corresponds to the X-ray radiation 101 produced by the X-ray source 100 after interaction with the target 104. The X-ray scintillation detector 120 is a layered device comprising a protection layer 401, an X-ray scintillator 402, a pixel array of α-silicon photodiodes 403, and a thin film transistor (TFT) sensor panel 404. The X-ray scintillator 402 (including any associated protection layers 401) corresponds to an example of the X-ray scintillator 105 of FIG. 1, while the combination of the pixel array of α-silicon photodiodes 403 and the thin film transistor (TFT) sensor panel 404 corresponds to an example of the optical transducer 106 of FIG. 1.

In operation, the X-rays 400 incident on the X-ray scintillation detector 120 pass through the protection layer and are then received into the X-ray scintillator material. Some of the X-rays 400 may pass through the X-ray scintillator 402, but other X-rays interact with the material of the X-ray scintillator—e.g. by being absorbed or scattered. The absorbed X-rays in effect deposit energy into the material of the X-ray scintillator, such as by raising electrons into excited states. This energy may then be released in the form of light, i.e. optical photons, as electrons decay from the excited states (or from existing states into lower, newly-vacated states). The light emitted by the X-ray scintillator 402 impinges onto the pixel array formed by silicon photodiodes 403, i.e. the photodiodes effectively represent pixels for the receipt of optical light from the X-ray scintillator 402. The pixels (photodiodes 403) produce electrical signals that are received and detected by the TFT sensor panel 404 for conversion into a digital image. This digital image generally corresponds to the distribution of X-rays 400 received onto the detector plane of the X-ray scintillation detector 120.

We note that the present disclosure is generally (but not exclusively) focussed on the X-ray scintillator detector 120, in particular the X-ray scintillator 402. Accordingly, the other components of the X-ray imaging system 10, such as the X-ray source 100 and the optical detector 106 may be mostly conventional (at least in some implementations). The X-ray scintillator 402 of the present disclosure can therefore be utilised if so desired with a wide range of conventional components for the X-ray source 100 and/or the optical detector 106, as already known to the skilled person. On the other hand, as described below, the X-ray imaging system 10 may be configured in some implementations to exploit particular features of the X-ray scintillator 402 disclosed herein, thereby extending beyond such conventional components.

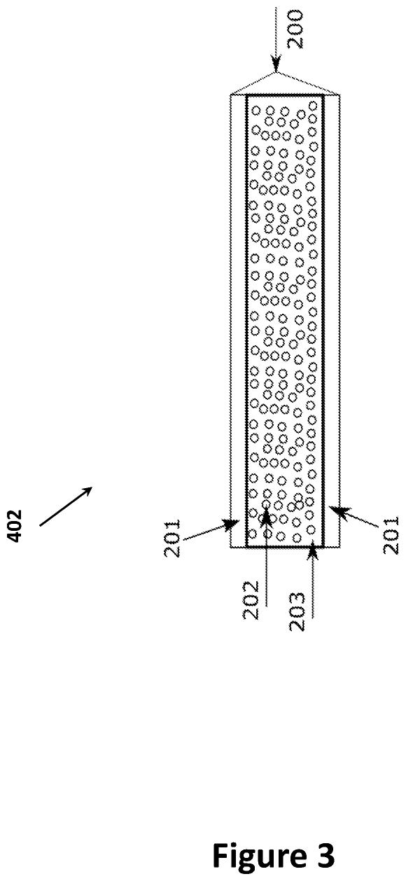

FIG. 3 is a schematic diagram of one example of an X-ray scintillator 402 for use in an X-ray scintillation detector 120 such as shown in FIG. 2 as part of an X-ray imaging device 10 such as shown in FIG. 1 in accordance with the present disclosure. The X-ray scintillator 402 comprises a film of material, e.g. particles such as nano/micro-crystals 202, which in some cases may be held within a matrix or resin of one or more polymers 200.

The thickness of this film is typically in the range 100-300 μm. The lower limit ensures a physically robust film containing sufficient nano/micro-crystals 202 to ensure good sensitivity. The upper limit is generally determined by the effect of self-absorption. In other words, there is a chance that light emitted by the nano/micro-crystals 202 is reabsorbed by the nano/micro-crystals 202, rather than escaping the nano/micro-crystals 202 to be incident on, and hence detected by, a photodetector 106. The amount of reabsorption can be restricted by keeping the film relatively thin, for example, below 300 μm in thickness, since this allows more of the light produced by incident X-rays to escape the film for subsequent detection by detector 106.

FIG. 3 further shows a barrier film 201 formed, for example, from a polymer which is provided on each side of the material 202—i.e. there is a first barrier film 201 formed on the back face (facing the target 104) and a second barrier film 201, opposing the first barrier film 201, formed on the front face (facing the silicon photodiodes 403). The barrier films 201 may be used to protect the material 202 from air, moisture, environmental contaminants such as dust and liquids, and so on.

The X-ray scintillator 402 of FIG. 3 may be varied according to the circumstances of any particular implementation. For example, one or both of the barrier films 201 may be omitted if the X-ray scintillator is to be used in a clean environment, and/or if the material 202 is itself reasonably robust against environmental contamination or degradation. Alternatively (or additionally), the resin or polymer matrix 200 may be omitted in some implementations. For example, in some cases the nano/micro-crystals 202 may be securely held between the two opposing barrier films 201 without the use of a resin or polymer matrix 200; in other cases, the material 202 may be adhered directly to one or both of the barrier films 201.

Examples of perovskite halide nano/micro-crystals for use in/as an X-ray scintillator 402 are CsPbBr₃, Cs₃Cu₂I₅, Rb₂CuBr₃, CsBa₂Br₅, CsBa₂I₅, CsCaI₅, Cs₄CaI₆, CsSrI₃, Cs₄SrI₆, Cs₂AgI₃ and KBa₂I₅. More generally, the halide perovskite nano/micro-crystals used to form X-ray scintillator 402 may have one of the following formulae: AMX₃, AM₂X₅, A₂MX₃, A₃M₂X₅, A₄MX₆., where A generally represents a cation, M is another cation, and X is an anion (or from another perspective, A represents a cation and the combination of M and X forms the anion).

In the above formulae:
A is a group I element (an alkali metal), or a combination of two or more such group 1 elements. The use of caesium for A is particularly attractive (as can be seen by the list of examples above) because caesium is the (non-radioactive) group I element with the highest atomic number Z, and this generally increases the stopping power of the material with respect to X-ray photons.
M is typically a metal selected from the group M=Pb, Cu, Ba, Ca, Sr, Bi, Sn, Ag or a combination of two or more such metals. Although there is quite widespread use of lead for making perovskite nano/micro-crystals, there is a problem with the toxicity of lead. Accordingly, the use of a lead-free material is particularly attractive. More generally, the present approach seeks to avoid the use of heavy metals, namely lead, mercury, cadmium and chromium, in favour of metals such as copper, barium, calcium and strontium (plus in some cases bismuth and/or tin).
X is a group VII element (a halogen), or a combination of two or more such group VII elements. The use of iodine for X is particularly attractive (as can be seen by the list of examples above) because iodine is the (non-radioactive) group VII element with the highest atomic number Z, and this generally increases the stopping power of the material with respect to X-ray photons.

In view of the above considerations, particularly attractive materials for forming halide perovskite nano/micro-crystals of the X-ray scintillator 402 include Cs₃Cu₂I₅, CsBa₂I₅, CsCaI₃, Cs₄CaI₆, CsSrI₃, Cs₂AgI₃ and Cs₄SrI₆. Of these materials, Cs₃Cu₂I₅ has some particular advantages in that it has good stability and also radiation hardness. Regarding the latter, this indicates that the scintillator material suffers relatively little degradation as a result of significant exposure to X-rays, and hence an X-ray scintillation device based on a Cs₃Cu₂I₅ perovskite material has a relatively long operational lifetime.

The material for forming halide perovskite nano/micro-crystals of the X-ray scintillator 402 may include a dopant, such as Europium (Eu), Thallium (TI), Cerium (Ce), Ytterbium (Yb), Tellurium (Te), Silver (Ag), Copper (Cu), Terbium (Tb), Praseodymium (Pr), Indium (In), Manganese (Mn), Copper (Cu) and Fluorine (F) (or combinations thereof). It has been found that various dopants such as thallium are able to: (i) increase the light output from the X-ray scintillator 402 and/or (ii) change the wavelength peak and distribution of the optical light output from the X-ray scintillator. For example, the use of a dopant may change the peak of emission from blue light to a longer, green wavelength. This ability to change the peak of emission from the X-ray scintillator may be useful for matching the light output from the X-ray scintillator 105 to the wavelength region of peak sensitivity for the photodetector 106 used to capture the light emissions from the X-ray scintillator 105.

This action of the dopant is believed to result from the dopant being incorporated into the crystal structure, for example, the dopant atoms might replace caesium atoms at some locations, which in turn modifies the conduction bands of the material (compared to an undoped crystal structure). In particular, the modification of the conduction bands may facilitate the decay of electrons to the ground (or other lower) electron state, which in turn increases the emission of light photons. (However, we do not exclude a possibility that one or more other mechanisms cause the dopant to increase light output from the nano/micro-crystal material).

There are various known methods available to synthesize halide perovskite nano/micro-crystals. One example of such a method is a hot injection method in which (for example) the cation precursor, such as Cs-oleate, and a metal halide precursor are added to a high boiling point solvent (e.g. octadecene) at a temperature in the range (for example) 140-200° C. A mixture (e.g. 1:1) of oleylamine and oleic acid may be added into the octadecene to solubilize the metal halide anions and to colloidally stabilize the resulting nano/micro-crystals. The size of the nano/micro-crystals can be controlled, inter alia, by changing the temperature of the reaction.

For more details of suitable methods for synthesizing halide perovskite nano/micro-crystals, see “Nanocrystals of Cesium Lead Halide Perovskites (CsPbX₃, X═Cl, Br, and I): Novel Optoelectronic Materials Showing Bright Emission with Wide Color Gamut” by Loredana Protesescu et al, in Nano Lettters, 2015, v5n6, pages 3692-3696, and the supplementary material provided for “Colloidal Synthesis of Ternary Copper Halide Nanocrystals for High-Efficiency Deep-Blue Light-Emitting Diodes with a Half-Lifetime above 100 h” by Lintao Wang et al, in Nano Lettters, 2020, v20n5, pages 3568-3576 (see https://pubs.acs.org/doi/10.1021/acs.nanolett.0c00513). The formation of halide perovskite nano/micro-crystals is also disclosed in US 2019/145587 (see paragraph et seq.).

The halide perovskite nano/micro-crystals may be surface passivated (capped) to improve stability and robustness against environmental factors such as moisture (as well as to enhance luminescence). Such passivation may be performed, for example, by capping the nano/micro-crystals with a ligand such as an inorganic-organic hybrid pair. By way of example, the capping ligand may be formed of (or based on) (i) sulphur (or similar)+dodecylamine (DDA) (e.g. di-dodecyl dimethylammonium chloride); (ii) halogen+DDA; or (iii) ammonium, phosphonium (or similar), e.g. in combination with a halogen. Such passivation is described, inter alia, in US2021214609 and WO2021081380 (which also provide additional teachings relating to the general synthesis of halide perovskite nano/micro-crystals).

In some implementations, the halide perovskite nano/micro-crystals may be further provided with a shell to provide additional protection for the halide perovskite nano-microcrystals. The provision of such a shell may be adopted as an alternative (or as an addition) to capping with ligands as described above. The shell may be based, for example, on silicon dioxide (SiO₂) or aluminium oxide (Al₂O₃) or any other suitable material, such as described in “Highly luminescent biocompatible CsPbBr₃@SiO₂ core-shell nanoprobes for bioimaging and drug delivery” by Pawan Kupal et al, in the Journal of Material Chemistry B, 2020 Dec. 7; volume 8 (45), pages 10337-10345.

The nano/micro-crystals prepared as above may be mixed with a polymer precursor or other solvent to form a paste, resin (e.g. acrylate resin), solution or similar which can then be deposited (e.g. poured) onto a substrate. Various additives may be included in this mix according to the particular materials and circumstances of any given implementation, such as phosphonium salt additive, photoinitiator, polymer blends (olygomers, monomers, polymers) and so on.

The polymer precursor may then be cured (or the solvent or resin heated) to form the X-ray scintillator film (sheet) shown in FIG. 3, in which the cured polymer (such as acrylate) forms the matrix or resin 200 which holds the nano/micro-crystals 202. This scintillator material, which is sometimes referred to as a nanosheet, comprises the film of the polymer matrix or resin holding the halide perovskite nano/micro-crystals 200 and may be protected on one or both sides by a barrier film 201 (although in some implementations one or both barrier films may be omitted). In some cases, the substrate onto which the paste or similar is deposited may act as one of the barrier films. This may be particularly appropriate if the nano/micro-crystals 202 are deposited onto the substrate when held in a solvent which is subsequently evaporated (rather than providing a holding matrix such as a resin or similar). In some applications, the nano/micro-crystals 202 may be provided (and in some cases subsequently utilised) in powder form.

In implementations in which the halide perovskite nano/micro-crystals are formed with a dopant, such dopant may be added to the raw materials used to form the nano/micro-crystals, such as Cs-oleate, and a metal halide precursor. The dopant may provide up to 12% of the mass of the doped halide perovskite nano/micro-crystals. By way of example, the dopant may provide between 2 and 12% or between 6 and 12% of the mass of the doped halide perovskite nano/micro-crystals. Increasing the percentage of dopant can lead to greater light production for a given intensity of incident X-rays (and hence greater sensitivity to such X-rays. However, having too much dopant may disrupt the crystal structure, and hence reduce performance. As shown in the experimental results presented below, a dopant level of 10% in halide perovskite nano/micro-crystals has been found to provide good sensitivity for X-ray detection.

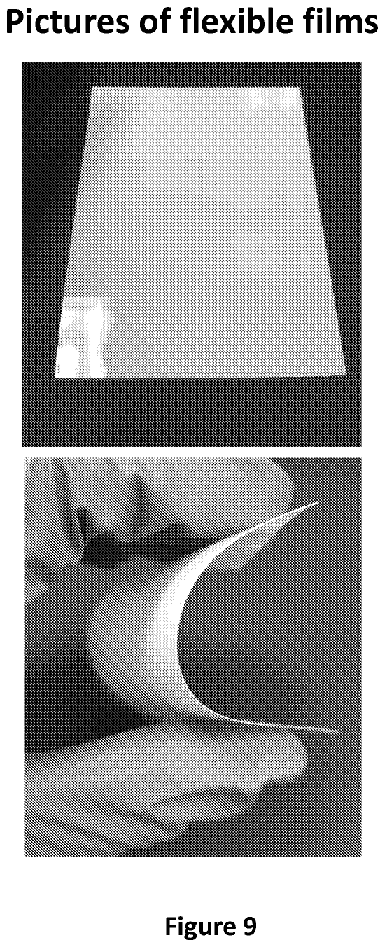

In contrast to many existing X-ray scintillators, which are based on large crystalline materials and/or provided on rigid substrates, such as glass, the X-ray scintillator 402 described above is primarily based on a polymer film (whether to embed the doped halide perovskite nano/micro-crystals 202 or to act as a substrate for receiving the doped halide perovskite nano/micro-crystals 202). For example, the film may comprise an acrylate polymer. Such a polymer film is generally flexible (for acrylate and other materials), in contrast to many existing X-ray scintillators which, as noted above, are rigid. An image of such a flexible X-ray scintillator material is shown in FIG. 9, which is discussed below. However, it will be appreciated that the doped halide perovskite nano/micro-crystals disclosed herein are not limited to use on or in a flexible substrate, but may also be used as appropriate with a rigid (non-flexible) substrate such as glass. Accordingly, the halide perovskite nano/micro-crystals disclosed herein can be used on or in any appropriate substrate (flexible or rigid) depending on the particular circumstances of any given implementation.

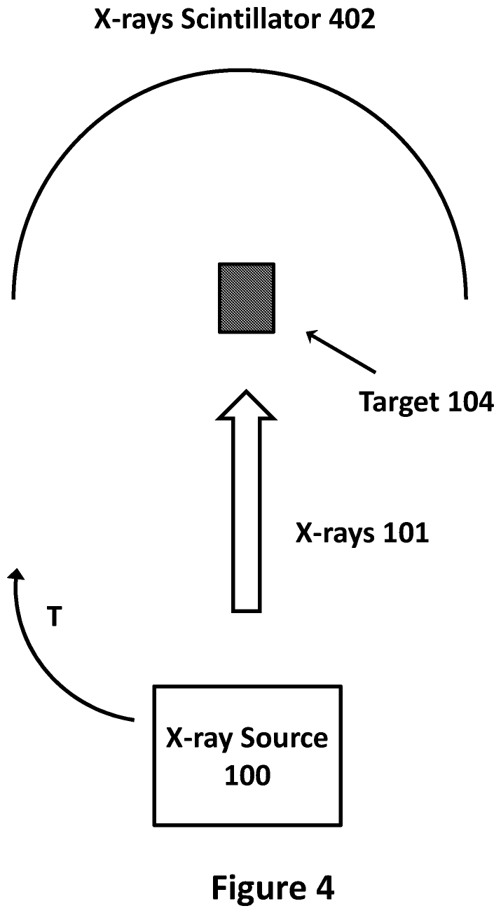

FIG. 4 is a schematic diagram of one example of the use of a flexible X-ray scintillator 402 such as described above in accordance with the present disclosure. Note that the overall context of FIG. 4 may be an X-ray imaging device 10 as described with reference to FIGS. 1 and 2 as disclosed above, but with a modification to the configuration of the X-ray imaging device 10 to utilise the flexible nature of the X-ray scintillator 402 (which corresponds to X-ray scintillator 105 in FIG. 1). Accordingly, as already discussed above in relation to FIG. 1, an X-ray source 100 is used to direct X-rays 101 at a target 104 with imaging then being performed by the X-ray scintillation detector 120 with respect to the transmitted and/or scattered X-rays. However, rather than having a flat (planar) X-ray scintillation detector 120 such as shown in FIG. 1, the X-ray scintillator 402 shown in FIG. 4 is curved around the target 104, with the target located at (or along) the axis of curvature of the X-ray scintillator. For example, the X-ray scintillator may be configured to have a radius of curvature less than 1 m, less than 0.50 m, less than 0.2 m, or less than 0.1 m, depending on the particular physical properties of the X-ray scintillator material, including the polymer or resin used to hold the nano/micro-crystals. The radius of curvature used in any given implementation will also depend on the physical parameters associated with the implementation, such as the size of the X-ray source 100 and the size of the target 104.

Note that the optical transducer or photodetector 106 combines with the X-ray scintillator 402 to form the X-ray scintillation detector (device) 120. The optical transducer 106 is not shown in FIG. 4, but can also be flexible (curved), for example, by mounting the optical detectors 106 (e.g. silicon photodiodes) on a flexible plastic substrate such as polyimide (see https://en.wikipedia.org/wiki/Flexible_electronics). The curvature of the flexible photodetector 106 can be arranged to match the curvature of the X-ray scintillator 402 such as shown in FIG. 4.

An advantage of placing the target 104 at the centre of curvature of the flexible X-ray scintillator 402 is that the distance from the target 104 to the X-ray scintillator 402 is constant for all locations on the X-ray scintillator. This means that the image acquired by the X-ray scintillation detector 120 has a consistent sensitivity in terms of both intensity and physical spacing, irrespective of the angle of X-rays 101 transmitted or scattered by the target 104, so the image is less distorted and hence easier to understand.

The configuration shown in FIG. 4 is most readily applied in a three-dimensional context to a target which is primarily elongated in one direction (axis). This axis of elongation can then be aligned with the axis of curvature of the flexible X-ray scintillator 402 (which is perpendicular to the plane of FIG. 4). It is noted that such a target shape (having one direction of elongation) is generally representative of human beings, in which height is much greater than width or depth (front to back), and so the configuration of FIG. 4 is suitable for medical imaging.

In various applications of X-ray imaging (including some medical and security imaging), it is desirable to scan across the target 104 to build up a tomographic (3-D volumetric) image of the target. In some cases the scanning may be performed by moving, e.g. rotating, the target, but this can be difficult or inappropriate for certain targets, such as human beings, fragile luggage, and so on. Accordingly, such scanning is often performed by rotating the X-ray source 100 relative to the target, such as indicated by arrow T in FIG. 4, and this generally involves also (co-) rotating an opposing detector to ensure consistency of the imaging. However, rotating both the X-ray source and the detector, whereby there are two moving parts of the system, can be inconvenient, especially in a busy, crowded environment, such as a medical operating theatre.

In contrast, the configuration shown in FIG. 4 allows the X-ray source 100 to be rotated about (scanned across) the target 104. However, the X-ray scintillation detector 120 can be maintained in the fixed position shown in FIG. 4 to receive X-rays from different scan positions without having to also rotate the X-ray scintillation detector 120. Avoiding such rotational movement of the X-ray scintillation detector 120 can help to simplify the structure and operation of the medical imaging device 10.

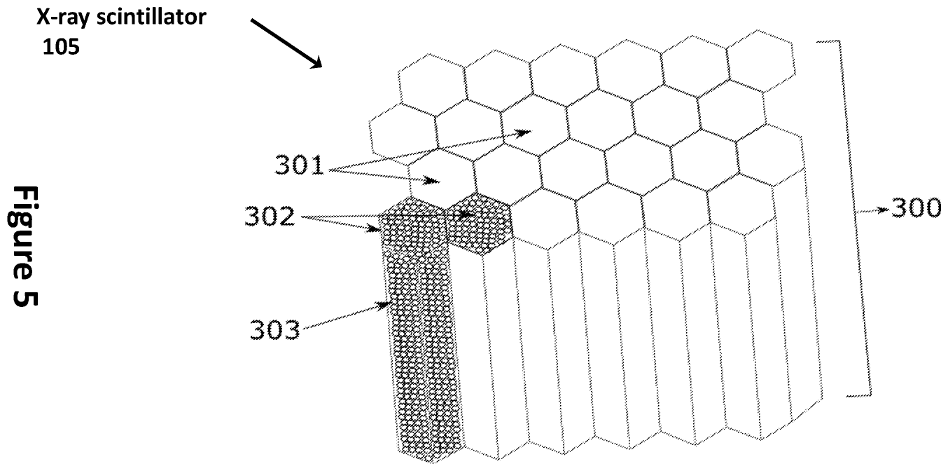

FIG. 5 is a schematic diagram of another example of an X-ray scintillator 105 which is a variation of the X-ray scintillator of FIG. 3, and which again is for use in an X-ray scintillation detector 120 such as shown in FIG. 2 as part of an X-ray imaging device 10 such as shown in FIG. 1 in accordance with the present disclosure.

As shown in FIG. 5, the X-ray scintillator 105 comprises a planar (and flexible) film 300 having a structured pattern of pores 301, 302. These pores extend perpendicularly to the plane of the film 300 and the cross-sectional shape of the pores is selected to map easily across the plane of the film. The pores may be formed by any suitable technique, such as etching into a substrate. Further information about the use of such a structured pattern of pores to hold X-ray scintillation materials can be found, for example, in “Compact x-ray microradiograph for in situ imaging of solidification processes: Bringing in situ x-ray micro-imaging from the synchrotron to the Laboratory”, by C. Rakete et al, in the Review of Scientific Instruments, v82, 105108, 2011 (see section F).

The pores in a structure such as shown in FIG. 5 may have a cross-section corresponding to a shape such as a regular hexagon, a square or rectangle, or an equilateral triangle or right-angled triangle, all of these shapes being able to tessellate across the plane, but other patterns of pores, including potentially combinations of different shapes and/or sizes may also be used. For example, in some cases the pores may be circular in cross-section with the walls of the pores being shaped as appropriate to fill the spacing between the different pores.

FIG. 5 shows some pores 301 which are empty and some pores 302 which are (partly) filled with nano/micro-crystals 303. It will be appreciated that in an operational X-ray scintillator 105, most or all of the pores 301, 302 are substantially filled with nano/micro-crystals 303 to act as an X-ray scintillator. Note that the nano/micro-crystals 303 may be implemented by nano/micro-crystals 402 as described above, however other forms of nano/micro-crystals 303 may also be utilised in the X=ray scintillator 105, as described in more detail below.

In some implementations, the pores 301, 302 may have a columnar structure in the form of shafts which extend all the way through the film 300, in other implementations the pores may only extend partway down through the film so that the pores all have a floor or base to retain the nano/micro-crystals in the pores. If the pores do extend all through the film 300, then a separate sheet or other film (not shown in FIG. 5) may be adhered or otherwise attached to the underside of the film 300 to cover and retain the nano/micro-crystals in pores 302. Similarly, after the pores 301, 302 have been filled with nano/micro-crystals, a similar sheet or film (not shown in FIG. 5) may be adhered or otherwise attached to the top of film 300 to cover and retain the nano/micro-crystals in the pores 302. Note that other approaches for retaining the nano/micro-crystals in the pores may also be adopted at the top and/or bottom of the pores 302, such as inserting plugs into the pores to close the pores and so retain the nano/micro-crystals in the pores. A further possibility is to embed the nano/micro-crystals in a resin or similar in the pores, whereby the resin holds the nano/micro-crystals in position in the pores (potentially without any other form of cover or retainer).

As shown in FIGS. 1 and 2, the X-ray scintillator 105 shown in FIG. 5 is combined with a photodetector 106, such as a set of photodiodes (not shown in FIG. 5), to provide an X-ray scintillation detector 120 which produces an electronic output in response to incident X-rays 101. The photodetector 106 generally has a planar shape matching and facing (opposing) the planar shape of the X-ray scintillator 105 such as shown in FIGS. 1 and 2, and also applicable to implementations using a curved (flexible) X-ray scintillator such as shown in FIG. 5.

The photodetector 106 typically has a pixel structure in order to image light from the X-ray scintillator 105. In the implementation of FIG. 5, the pattern of pixels generally matches (corresponds to) the pattern of pores 301, 302, in other words, there is a one-to-one mapping between individual pores in the X-ray scintillator 105 and the pixels of the photodetector 106. This matching is relatively straightforward if the pores have a square or rectangular cross-section which can then be directly mapped to pixels of a similar shape. In the case of a hexagonal pattern for the pores (such as shown in FIG. 5), one way of forming the pixels would be to use square pixels, each pixel having a square shape which is small enough to fit within a single hexagon. The photodetector 106 may be provided with rows of such square pixels corresponding to respective rows of hexagonal pores 302 in the film 300, in which the squares are all slightly separated from one another to accommodate the edges of the hexagons. In addition, alternate rows of the square pixels may be offset from one another by half the pixel separation to provide an ABABA configuration of pixels to match the pattern of hexagons, which also is in the form of an ABABA configuration.

The material of the film 300 is generally opaque, so that optical light produced within a given pore cannot travel into a neighbouring pore. However, the ends of the pores facing (immediately adjacent to) the optical transducer or detector 106 (see e.g. FIG. 1) are open or have a cover which is transparent to the optical light which is produced by X-ray scintillation of the nano/micro-crystals 303. Light is therefore able to exit the pores through this opening or transparent cover and then impinge on the optical transducer 106 for electronic detection. In particular, light from any given pore exits onto the respective pixel corresponding to the given pore for detection by the X-ray scintillation detector 120.

Although the use of a columnar structure for film 300 may potentially reduce the total amount of light received by the photodetector 106 (for example, some of the light produced in response to the incident X-rays may be absorbed by the material of the columnar structure), the light that does get emitted has a much better localisation. Thus for each X-ray photon (from X-rays 101) striking and interacting with nano/micro-crystals 303, multiple optical photons may be produced because the energy of an X-ray photon is many times higher than the energy of an optical photon. Depending on the details of the interaction between the X-ray photon and the nano/micro-crystals 303, the optical photons produced by the X-ray scintillator material may travel in various directions consistent with some (relatively wide) point spread function for the interaction. In contrast, for the implementation shown in FIG. 5, which uses the columnar structure for holding the nano/micro-crystals, the walls of the pore act as a form of collimator, directing the optical photons produced by an incident X-ray photon onto the particular pixel corresponding to the particular pore which received the X-ray photon. Therefore, the film 300 of FIG. 5 in effect restricts the point spread function of light from an X-ray interaction to the width of a single pore, which may be much narrower than the point spread function for light produced by an X-ray scintillator 105 which does not have such a pore structure. It will be appreciated that using a columnar structure for film 300 to restrict the point spread function in this way results in X-ray images having a higher spatial resolution. In particular, the spatial resolution of the images produced by the optical photodetector 106 will generally correspond to the size of a single pore (and hence to the size of a single pixel). In contrast, in the absence of such a columnar structure for film 300, the point spread function is broader (there is more scattering because the optical photons are not constrained to individual pores/pixels). As a result, the images produced by the optical photodetector 106 from such an unstructured X-ray scintillator 105 will generally have greater noise and the spatial resolution will be lower compared to an X-ray scintillator 105 having the patterned structure of FIG. 5.

Note that patterned structures 300 for high resolution X-ray imaging have previously been used. Typically, such a film 300 having a patterned structure has been filled with scintillator material by melting the material at a relatively high temperature, allowing the molten material to flow into and fill the pores in the patterned structure, and then allowing the molten material to cool down and re-crystallize in the pores. However, such high temperature processing is relatively complex and the re-crystallization of the scintillation material within the pores may be difficult to control.

In contrast, the pores 301, 302 in the X-ray scintillator 105 of FIG. 5 are filled with nano/micro-crystals (whereas existing devices that use patterned structures for high resolution X-ray imaging generally do not use or generate nano/micro-crystals within the pores). The direct use of nano/micro-crystals within patterned structures 300 for high resolution X-ray imaging (i.e. without melting and then (re) crystallisation) avoids the use of high temperature processing. In addition, the scintillation material, namely the nano/micro-crystals 303, may be tested for a specified performance level prior to insertion into the film 300. In contrast, with the existing approach, the scintillation material is only formed in situ within the pores after the recrystallisation, and so cannot be tested at an earlier stage of the procedure.

The size of the pores 301, 302 in a direction parallel to the plane of the film 300, i.e. corresponding to the opening of the pore, is significantly greater than the average size of the nano/micro-crystals 303. For example the size of the pores 301, 302 may exceed the size of the nano/micro-crystals by a factor of at least two, by a factor of at least 5, by a factor of at least 10, or by factor of at least 20; the size of the pores may be in the range 1 μm to 1 mm, within the range 5 μm to 500 μm, or within the range 20 μm to 200 μm. The average size of the nano/micro-crystals may be in a range having a lower bound of 1 nm, 2 nm, 5 nm, 10 nm, 15 nm, 25 nm, 50 nm, 100 nm, 200 nm, 500 nm or 1 μm and an upper bound (larger than the lower bound) of 1 μm, 2 μm, 5 μm, 10 μm, 15 μm, 20 μm, or 50 μm. In some implementations, the nano/micro-crystals have a size which is relatively small compared to the size of the pores 301, 302 in the patterned film, e.g. 10-220 μm. The small size of the nano/micro-crystals 303 compared to the pore openings facilitates filling the nano/micro-crystals 303 into the pores 301, 302. Such filling can be performed directly with the nano/micro-crystals themselves, i.e. analogous to a dry powder, or by first dispersing the nano/micro-crystals into a medium, for example, a paste, a solvent, a liquid polymer, etc, to form a material having a desired concentration of nano/micro-crystals. The pores can then be filled with the medium containing the nano/micro-crystals 303 using any appropriate technology, for example by solution processing—e.g. soaking, deposition, spin coating, inkjet printing, lithography, spray-coating, and so on. Such filling techniques generally provide better scaling for application to large area deposition and filling of pores compared to the existing high-temperature approach to filling the pores by melting and then re-crystallisation.

The planar film 300 is typically made from an insulating substance such as silicon dioxide (SiO₂), aluminium oxide (Al₂O₃), silica (Si), titanium dioxide (TiO₂) and/or polymers. There are various ways available for producing the film 300, including 3-D printing and a conventional lithographic process to etch the pores. The film 300 is typically flexible (both before and after filling with nano/micro-crystals 303) and hence can be utilised in a manner such as shown in FIG. 4 (and as discussed in relation thereto).

The film 300 shown in FIG. 5 may be used with a wide variety of nano/micro-crystals to provide an X-ray scintillator, such as halide perovskite nano/micro-crystals, halide nano/micro-crystals, oxide perovskite nano/micro-crystals, metal oxysulfide nano/micro-crystals and metal sulfide nano/micro-crystals. Examples of halide perovskite nano/micro-crystals are CsPbBr₃, Cs₃Cu₂I₅, Rb₂CuBr₃, CsBa₂Br₅, CsBa₂I₅, CsCaI₃, Cs₄CaI₆, CsSrI₃, Cs₄SrI₆, Cs₂AgI₃, KBa₂I₅; examples of halide nano/micro-crystals are CsX, LuX₃, LaX₃, NaX, SrX₂, BaX₂, CaX₃ (X═Cl, Br, I); examples of oxide perovskite nano/micro-crystals are CaWO₄, PbWO₄, CdWO₄; examples of metal sulfide, metal oxysulfide, metal silicate, and metal oxide nano/micro-crystals include, PbS, CdS, ZnS, Gd₂O₂S, Lu₂₍₁₋ₓ₎ Y₂ₓSiO₅, Bi₄Ge₃O₁₂.

The X-ray scintillator 105 shown in FIG. 5 may also be formed with doped nano/micro-crystals. For example, the nano/micro-crystals 303 may be synthesized with one of the following dopants Europium (Eu), Thallium (TI), Cerium (Ce), Ytterbium (Yb) Tellurium (Te), Silver (Ag), Copper (Cu), Terbium (Tb), Praseodymium (Pr) and Fluorine (F), Manganese (Mn) and Indium (In). As discussed above, the use of such dopants can lead to greater light output from the X-ray scintillator material, and may also allow the wavelength of the emitted light to be adjusted for better matching to the peak sensitivity of the photodetector 106.

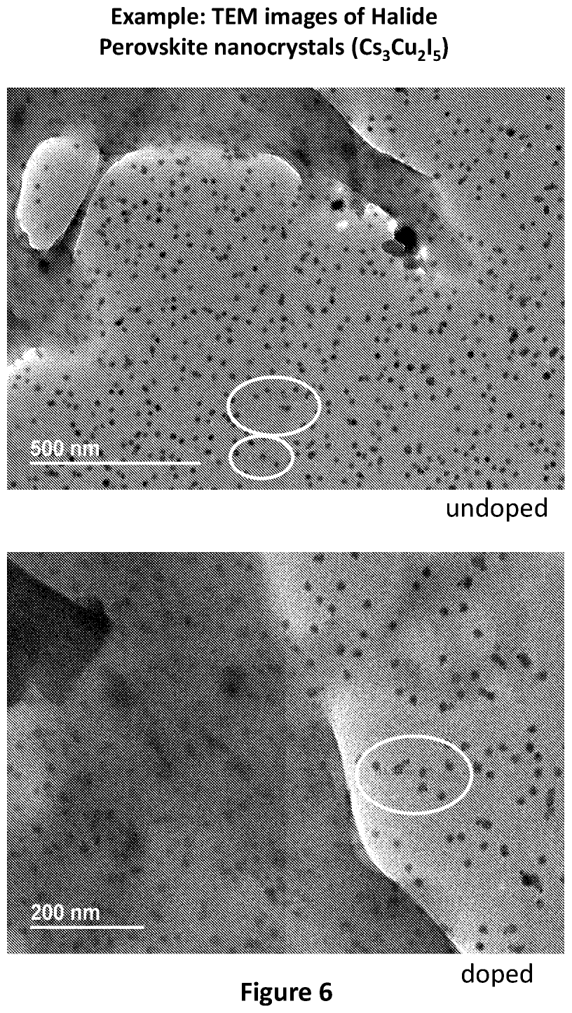

FIG. 6 shows two images obtained using transmission electron microscopy (TEM) showing the detailed structure of an example of an X-ray scintillator in accordance with the present disclosure. In both cases the perovksite material for the X-ray scintillator comprises halide perovskite nanocrystals (Cs₃Cu₂I₅). The image shown on the top is for undoped perovskite nanocrystals, the image shown on the bottom is for doped perovskite nanocrystals with a doping level of approximately 10%. Please note that substantially the same material, namely (Cs₃Cu₂I₅) halide perovskite, with or without 10% thallium doping, is used as the basis for the experimental results shown in FIGS. 6-11.

For both images of FIG. 6, the perovskite nanocrystals appear as dark (black) dots (the light, broader structure in these two images is primarily due to the TEM imaging process, and hence is not of interest for present purposes). Each image is marked with a scale (see bottom left corner), in particular, the top image has a scale-line representing 500 nm and the bottom image has a scale-line representing 200 nm. For both images, at least one white circle or ellipse has been superimposed. This white shape marks a region where the size of selected (representative) nanocrystals has been measured. The three measured nanocrystals for the undoped material (top image) have an approximate size of 11.3, 12, and 14.9 nm, while the two measured nanocrystals for the doped material (bottom image) have an approximate size of 11.4 and 13.3 nm. It will be appreciated that these sizings confirm that the perovskite of FIG. 6 is formed of nanocrystals (rather than say microcrystals). In addition, it is noted that there is no readily apparent visible difference between the undoped and doped nanocrystals; rather, they share a similar sizing, spacing and distribution of the halide perovskite nanocrystals.

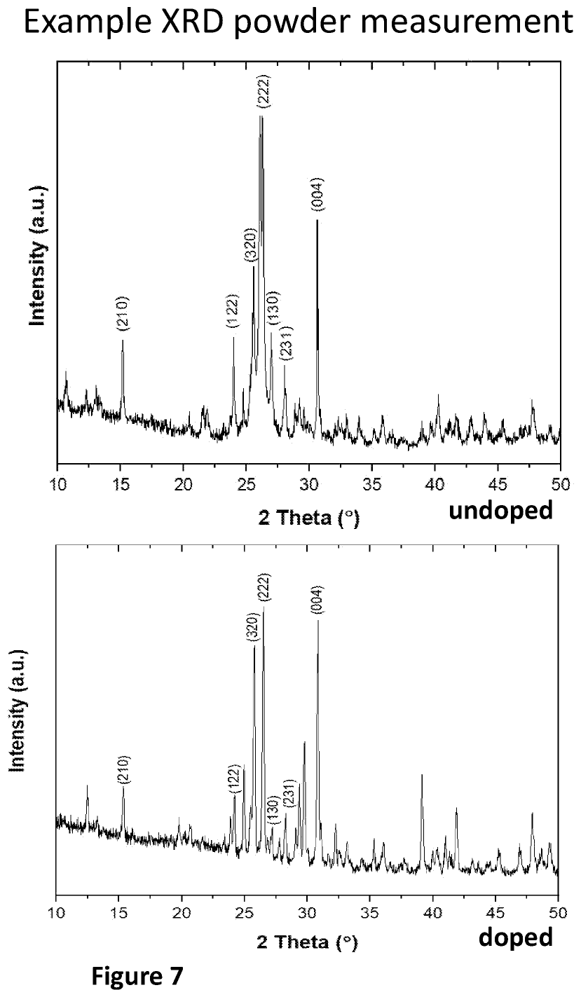

FIG. 7 shows two X-ray diffraction (XRD) plots obtained from an X-ray scintillator in accordance with the present disclosure. The top XRD plot is for undoped halide perovskite nano/micro-crystals and the bottom XRD plot is for doped halide perovskite nano/micro-crystals. As noted above, these measurements were obtained with respect to the same undoped and doped material shown in the TEM images of FIG. 6, namely Cs₃Cu₂I₅ with (for the bottom image) thallium doping of approximately 10%. The X-axis in the plots of FIG. 7 corresponds to the angle of X-ray diffraction, while the Y-axis corresponds to the intensity of diffracted X-rays at that particular angle.

In both plots of FIG. 7, various peaks of intensity are labelled as corresponding to particular planes within the crystalline structure. In particular, each label comprises a 3-dimensional vector which is normal (perpendicular) to the plane responsible for producing the corresponding peak. It can be seen that the top and bottom XRD plots for the undoped and doped material respectively are very similar. In particular, the same peaks are discernible in both plots at the same wavelengths. This indicates that the general crystalline structure is the same for the undoped and doped halide perovskite material—in effect, the dopant may act at some locations as a substitute, e.g. for caesium, in the crystal structure.

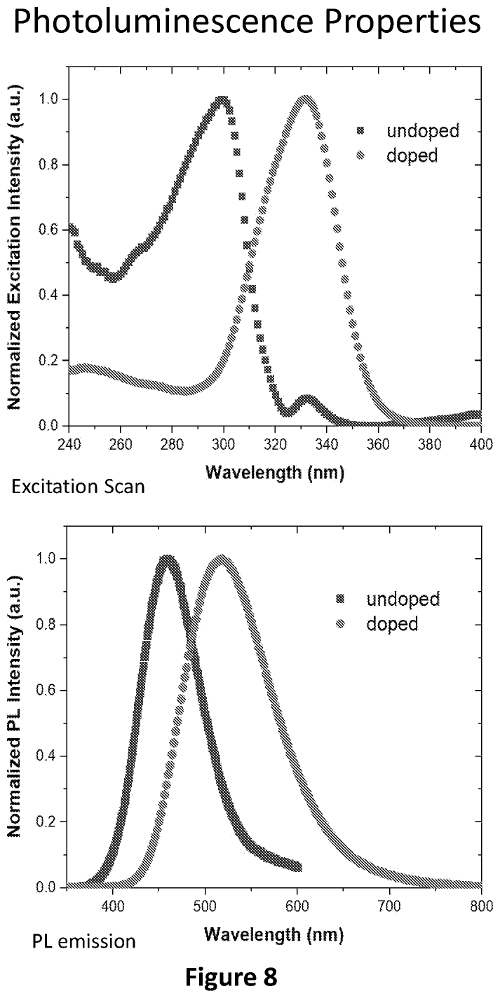

FIG. 8 shows two plots obtained from exciting an X-ray scintillator in accordance with the present disclosure. The top plot shows the variation of the excitation light, and the bottom plot shows the variation with wavelength of photoluminescent light emission in response to the excitation light. Note that these measurements were again obtained with respect to the same undoped and doped material shown in the TEM images of FIG. 6, namely Cs₃Cu₂I₅ without and with Thallium (TI) doping of approximately 10%. In particular, for each of the left-hand and right-hand plots, the curve in black corresponds to the undoped halide perovskite nano/micro-crystals, and the curve in red (in each case, shifted to the right, i.e. greater wavelength) corresponds to the doped halide perovskite nano/micro-crystals.

For both the top and bottom plots of FIG. 8, the X-axis corresponds to wavelength. It will be noted that the wavelength range for the absorbed excitation light shown in the top plot is approximately 250-360 nm. This wavelength range corresponds generally to ultra-violet (UV) radiation, which is used as a surrogate for X-rays in this particular investigation (since in practical terms, UV sources are more readily accessible than X-ray sources).

For the top plot of FIG. 8, the Y-axis represents the amount of excitation light provided (for each given wavelength), which also corresponds to the amount of UV light absorbed by the X-ray scintillator. For the bottom plot of FIG. 8, the Y-axis represents the amount of photoluminescent light emitted by the X-ray scintillator (for each given wavelength) in response to the absorption of the excitation light. Note that for both the left-hand and right-hand plots of FIG. 8, the scale of the Y-axis has been normalised. For example, with regard to the top plot showing emission (light output), the maximum (peak) light output at any given wavelength is represented as having an intensity of 1, and the light output at all other wavelengths is shown with a relative value (with respect to the peak) between 0 and 1. An analogous normalisation has been applied to the left-hand plot.

It is apparent from the top plot that the undoped halide perovskite nanocrystals generally absorb light in the range 260-320 nm, while the doped halide perovskite nanocrystals generally absorb light in the range 290-370 nm. Accordingly, it can be seen that the doping has shifted the absorption peak to a slightly longer wavelength. (Note however that this behaviour shown in the top plot of FIG. 8 may not apply for excitation by X-rays; rather, the wavelength (energy) profile of X-ray interaction and absorption may be much broader, and with little or no difference between the doped and undoped materials).

Looking at the bottom plot of FIG. 8, it can be seen that in response to the excitation light, the undoped halide perovskite nanocrystals generally emit light in the range 400-550 nm, while the doped halide perovskite nanocrystals generally emit light in the range 425-650 nm. Accordingly, it can be seen that the doping has the effects of moving the peak of light emission to a lower wavelength. This ability to shift the peak wavelength for the emission of photoluminescent output may be useful to help better align the wavelength distribution of the emission of photoluminescent output with the wavelength sensitivity curve of the photodetector 106, so that the peak light emission occurs at (or near) the wavelength at which the photodetector has greatest sensitivity.

FIG. 9 shows two images (photographs) of an example of an X-ray scintillator 105 in accordance with the present disclosure. The X-ray scintillator again incorporates the same undoped and doped material shown in the TEM images of FIG. 6. The scintillator is formed as a flexible film, analogous to the film 202 shown in FIG. 3, which may be used to form an X-ray scintillator 402 such as shown in FIG. 4. In the top image, the X-ray scintillator 105 is shown substantially flat, while in the bottom image, the X-ray scintillator is shown in a curved configuration. Accordingly, as shown in the bottom image, the film 202 of the X-ray scintillator is flexible, and may therefore be used, for example, in the configuration shown in FIG. 4.

The bottom image of the flexible film has the film held by a hand (wearing gloves), and this indicates an average radius of curvature of the film of the order of 2-3 centimetres, or more broadly in the range 1-5 cm. This range for the radius of curvature is intended to reflect the curvature shown in FIG. 9, rather than representing any particular limit on how small or how large a curvature can be applied to the film. It will be appreciated that supporting a high level of curvature such as shown in the right-hand portion of FIG. 9 allows more design options for developers of equipment that utilises or incorporates an X-ray scintillator (compared to existing X-ray scintillators, which have generally been provided as, on or within a rigid substrate or other structure).

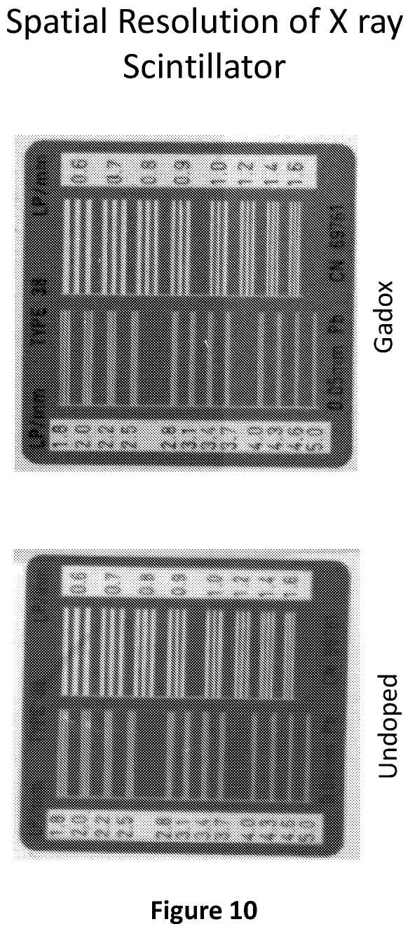

An important parameter for an X-ray imaging detector is spatial resolution. FIG. 10 shows two X-ray images of a target which is designed to measure the spatial resolution of the imaging process. In the bottom image, the X-ray scintillator used to acquire the image is an example of an undoped halide perovskite in accordance with the present disclosure and again incorporates the same undoped material shown in the top TEM image of FIG. 6. The top image was acquired using a gadolinium oxysulfide (Gadox-Gd₂O₂S) X-ray scintillator (as discussed above).

The target is formed from a 0.05 mm thickness of lead and contains multiple triplets of slits (lines) through the lead, each triplet comprising three parallel slits of constant length. The target contains two columns of slits, each column shrinking the spacing (and width) of the slits as you progress down the column. The target is calibrated to measure the triplets in terms of line pairs per millimetre (mm). The largest slit spacing (and slit widths) is for the triplet at the top of the right-hand column of the target (as viewed in the image)—this represents a slit spacing of 0.6 line pairs per millimetre. Progressing down this right-hand column, the triplet at the bottom right of the target has a slit spacing corresponding to 1.6 line pairs per millimetre. Transferring to the top of the left-hand column, this has a triplet with a slit spacing of 1.8 line pairs per millimetre, while progressing to the triplet at the bottom of the left-hand column, this has a slit spacing of 5.0 line pairs per millimetre.

For testing purposes, the target is typically placed directly on top of (or otherwise immediately adjacent to) the X-ray scintillator material. The target is then exposed to X-rays, whereby X-rays that are not incident on the slits are absorbed by the lead, while X-rays that are incident on the slits are able to pass through to interact with the underlying X-ray scintillator 105 to generate light which is then recorded by a suitable photodetector 106 to obtain the X-ray images shown in FIG. 10.

In broad terms, it can be seen that the resolution of the top image (Gadox) is somewhat better than the resolution of the bottom image (undoped halide perovskite nano/micro-crystals as described above in relation to the images of FIG. 6). For example, at 2.5 line pairs per millimetre, it is difficult to see (resolve) the triplet lines in the left-hand X-ray image obtained with the halide perovskite nano/micro-crystals, but the triplet lines are still visible in the right-hand image obtained with the Gadox X-ray scintillator.

The spatial resolution measured in these two X-ray images can be quantified based on a modulation transfer function (MTF) with respect to the on-off transmission (modulation) pattern associated with each triplet. A value of MTF=1 indicates that this modulation pattern is fully reproduced in the X-ray image. In contrast, a value of MTF=0 indicates that the modulation pattern is completely lost—in effect the three slits of a triplet merge completely together, and can only be seen in the X-ray image as a single, combined or aggregate slit.

The quantification of the spatial resolution testing shown in FIG. 10 was based on achieving a value of MTF=0.1. According to this condition, the undoped halide perovskite nano/micro-crystals could resolve line pairs down to a spacing of 2.3 line pairs per millimetre, while the Gadox-based scintillator could resolve line pairs down to a spacing of 3.1 line pairs per millimetre. Results for the thallium-doped halide perovskite nano/micro-crystals indicate that the limit of resolution (for MTF=0.1) is in the range 3.5-4 line pairs per millimetre.

Accordingly, while undoped halide perovskite nano/micro-crystals may provide lower spatial resolution than known Gadox devices, the doped halide perovskite nano/micro-crystals provide higher spatial resolution than known Gadox devices. This increase in spatial resolution for doped halide perovskite nano/micro-crystals compared with undoped halide perovskite nano/micro-crystals may arise from the increased light output of the former compared with the latter (for a given X-ray input). Such an increased output light intensity is able to enhance spatial resolution in the presence of noise, because the increased intensity improves the signal to noise ratio, which in turn allows better spatial information to be extracted from the image. This is important, for example, in the context of X-ray medical imaging, where an increase in spatial resolution is beneficial for diagnostic purposes, however, it is not desirable to increase the intensity of X-rays used for the imaging for medical reasons. In such a context, doped halide perovskite nano/micro-crystals as disclosed herein may be used as an X-ray scintillator to provide increased light output and also greater spatial resolution than existing devices without having to increase the X-ray exposure to a patient (or to provide the same spatial resolution as existing devices, but with a lower X-ray exposure to a patient).

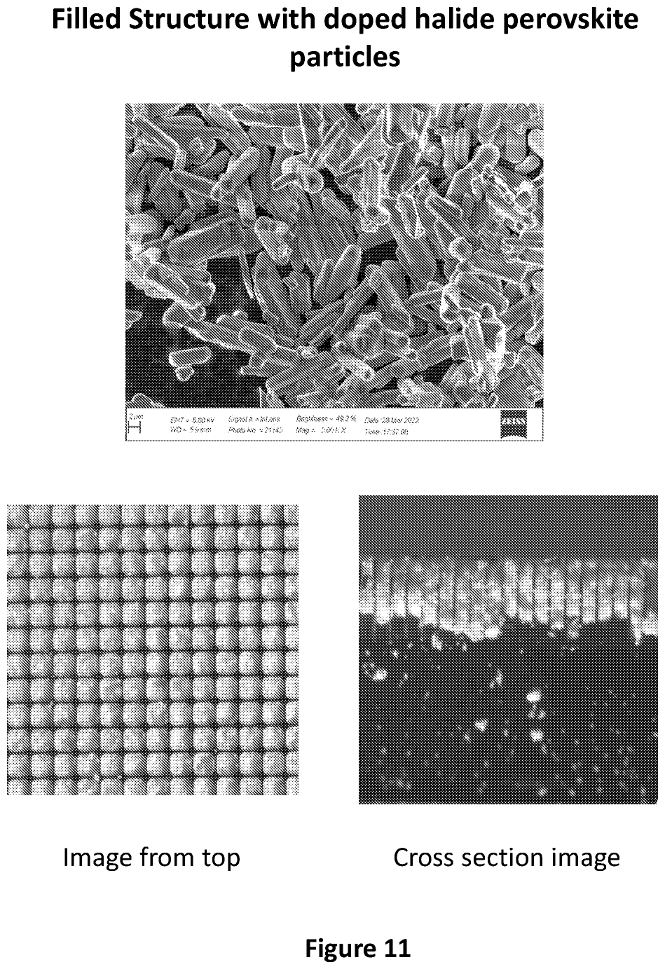

FIG. 11 comprises three images, one depicting microcrystals and the other two depicting a structure having pores (such as illustrated in FIG. 5) for holding such microcrystals. The top image in FIG. 11 is a TEM image of doped halide perovskite microcrystals. The composition of this material is the same as in the (doped) examples in FIGS. 6-10, namely Cs₃Cu₂I₅ with 10% thallium doping. However, compared to the nanocrystals of FIG. 6, the top image of FIG. 11 depicts microcrystals. As mentioned above, the size of the crystals (e.g. nanocrystals or microcrystals) can be controlled, inter alia, by adjusting the temperature of a synthesis procedure.

The top image of FIG. 11 includes a scale bar showing a sizing of 2 microns (μm), which can be used to confirm that the crystals in this image are larger than the crystals in FIG. 6—microcrystals rather than nanocrystals. The use of microcrystals (rather than nanocrystals) may provide a greater output luminosity for the same incident intensity of X-rays, for example because microcrystals may have a greater effective X-ray cross-section than nanocrystals. The microcrystals shown in the top image of FIG. 11 have a distribution of sizes (lengths) primarily in the range 2-16 microns (μm). The upper limit of this range may be based on the ability to fill the microcrystals into the pores as discussed below (the lower limit of this range may reflect the size distribution which arises from the production method).

FIG. 11 further provides two (bottom) optical images of a structure having a pattern of pores to produce an X-ray scintillator analogous to that illustrated in FIG. 5. The bottom left image is a view from above the structure showing the pores filled with microcrystals such as shown in the top picture of FIG. 11. The pores shown in this bottom left image are substantially square in shape when viewed from above, i.e. in a plan view, and hence tessellate across the surface of the X-ray scintillator 105.

The bottom right image in FIG. 11 is a cross-section through the patterned structure shown in the bottom left image of FIG. 11. The cross-section is with respect to a plane which is perpendicular to the plan view of the central image and also perpendicular to an axis defined by the rows of pores. This view clearly shows the pores being substantially filled with the micro-crystals.

As discussed above in relation to FIG. 5, the microcrystals are generally formed prior to insertion into the pores (compared to say filling the pores with a liquid that then solidifies in the pores). To facilitate such filling by nano/micro-crystals, the sizing of the nano-/micro-crystals should be significantly smaller than that of the pores, for example, by a factor of two or more, e.g. a factor of two, three, four, five, six, eight or ten. The pores shown in the two bottom images of FIG. 11 have a typical size of around 50 μm (for each side), and so can be readily filled with the microcrystals shown in the top image of FIG. 11, which have sizes in the approximate range 2-16 μm.

After the halide perovskite microcrystals shown in the top image of FIG. 11 have been used to fill the pores of the scintillator structure as shown in the two bottom images of FIG. 11 to produce an X-ray scintillator 105, this can be combined with a photodetector 106 to form an X-ray scintillation detection device 120 such as shown in FIG. 1. Note that the photodetector 106 may be placed above or below the X-ray scintillator (according to the orientation of the cross-sectional image, bottom right in FIG. 11). In the former case, the photodetector may help to retain the microcrystals within the pores (which are initially open at the top to allow filling). However, in other implementations, some other transparent barrier may be provided between the photodetector and the pores (for example, to prevent any undesired interaction between the microcrystals and the photodetector).

The testing of the spatial resolution of an X-ray scintillator discussed above with reference to FIG. 10 has also been performed with a film having structured pores to contain the scintillation material (halide perovskite microcrystals) such as shown in FIG. 11. Adopting a resolution limit of MTF=0.1 as before, an X-ray scintillator using doped halide perovskite microcrystals with the structured pores shown in FIG. 11 has been able to achieve a resolution in the range 10-20 line pairs per millimetre. This improved resolution (compared say to a standard film without pores having a resolution performance around 3.5-4 line pairs per millimetre) is considered to arise because the pore structure limits light scattering within the scintillator material. In effect, a pore forms a columnar structure which allows light to exit at the end of the pore, but prevents the light from escaping through the sides of the pore, thereby providing a (comparatively high) spatial resolution. This understanding is confirmed in that a pore size of 50 μm corresponds to 20 line pairs per millimetre, which is consistent with the measured resolution.

As discussed above, there is a dependency between the size of the nano/micro-crystals and the size of the pores in the scintillator structure—in particular, the latter must be large enough to be easily filled with the nano/micro-crystals. Conversely, there is an interest in keeping the pore sizes relatively small, because having a larger pore size will generally lead to a lower (less fine) spatial resolution, because the pore size in effect corresponds to the spatial resolution. Other factors such as ease of fabrication and strength may also impact the selection of pore size. The approach described herein may be used, for example, with a pore size in the range 1-10 μm, 10-20 μm, 20-40 μm, 40-60 μm, 60-80 μm, 80-100 μm, or 100-150 μm in any composite (contiguous) range defined by two or more of any of the preceding ranges. The depth of the pores is most typically in the range 150-300 μm, most typically in the range 230-300 μm, which as mentioned above gives a good balance between strength of the film containing the pores and avoiding self-absorption.

The choice of size for the nano/micro-crystals may depend on the light output from different size crystals, the size of pore to be filled with the nano/micro-crystals (if a structure with pores is to be used for the scintillator), and any other relevant factors. The approach described herein may be used, for example, with a crystal size in the range 1-50 nm, 50-250 nm, 250-1000 nm, 1-20 μm or 20-50 μm, or in any composite (contiguous) range defined by two or more of any of the preceding ranges.

In some implementations, after the pores have been filled with (doped) multiple nano/micro-crystals per pore, e.g. more than 10, 20, 50, 100, 200, 500 or 1000 nano/micro-crystals per pore, the structure of pores is heated, typically to a temperature in the range 400-600° centigrade, for a duration typically in the range 3-12 hours. Such heating causes the multiple nano/micro-crystals per pore to melt and join together and form a single (micro) crystal in each pore which substantially fills the pore. By way of example (and without limitation), such an implementation having a single crystal per pore may be produced by heating a structure of pores containing doped halide perovskite nano/micro-crystals such as (doped) Cs₃Cu₂I₅ as the scintillator material.

The scintillator produced by this additional processing step has certain advantages (compared with having multiple nano/micro-crystals per pore). Typically there is less scattering when using a single crystal per pore (because there is no scattering at the interface between different crystals in the pore), and this reduction in scattering can help to provide better resolution. In addition, the density of the single crystal per pore is above that of the multiple nano/micro-crystals per pore (because the air space between different nano/micro-crystals is eliminated), and this can help to provide better sensitivity. Furthermore, it is generally easier to retain in the pore a single crystal that substantially fills the pore than it is to retain multiple nano/micro-crystals in a pore.

It will also be appreciated that filling the pores first with multiple (doped) nano/micro-crystals per pore and then melting may be more convenient than first melting the multiple nano/micro-crystals and then filling into the pores. Thus in the former, the initial filling of the nano/micro-crystals into the pores can be performed at room temperature, followed by heating the multiple nano/micro-crystals per pore in situ. In contrast, in the latter, the filling of the pores with molten nano/micro-crystals requires this filling stage also to be performed at high temperature, which may increase complexity and cost.

In another implementation, the heating applied to the pores may not just be used for melting, but also to perform a chemical reaction that leads to the formation of the desired X-ray scintillator material. In this approach, each pore is filled with two or more compounds (reactants or precursor) which when heated together will produce a single crystal in each pore of the desired X-ray scintillation material, the single crystal substantially filling the pore in which it is located. Note that the reactants are typically mixed together prior to filling into the pores; this is generally more convenient than providing each reactant separately into the pores and then mixing (although this latter approach may also be used if so desired). The reactants are generally heated in the pores in a similar manner to that described above, i.e. typically to a temperature in the range 400-600° centigrade, for a duration typically in the range 3-12 hours.

The reactant materials may be provided into the pores in any suitable form, such as a powder, in crystalline form, in amorphous form, etc. The reactants may or may not exhibit X-ray scintillation in their precursor form. The reactants may be provided in stoichiometric amounts, so substantially all the reactants are consumed in making the single crystal of X-ray scintillator material for each pore, thereby ensuring that performance of the of X-ray scintillator material is not degraded by unconsumed residue. The reactants may include a dopant, e.g. any suitable dopant as described herein and with a concentration as described herein. By way of example (and without limitation), the reactants may comprise CsI, CuI and TII in order to make the single crystal of halide perovskite Cs₃Cu₂I₅ doped with TI as the scintillator material.

It will be appreciated that this approach is based on 3-stages, namely mixing the reactants, filling the mixed reactants into the pores, and then heating the pores to provide a chemical reaction for creating the X-ray scintillator material as a single crystal within (and substantially filing) each pore. In contrast, the approach described above using nano/micro-crystals to make the X-ray scintillator comprises four stages, namely mixing the reactants, heating to form the nano/micro-crystals, filling the nano/micro-crystals into the pores, and then heating the nano/micro-crystals in the pores to form a single crystal in each pore. Accordingly, it will be seen that the former method of producing the X-ray scintillator using a chemical reaction performed by heating the pre-cursors (reactants) in the structured pores may be quicker and more efficient than the latter method based on using multiple nano/micro-crystals in each pore.

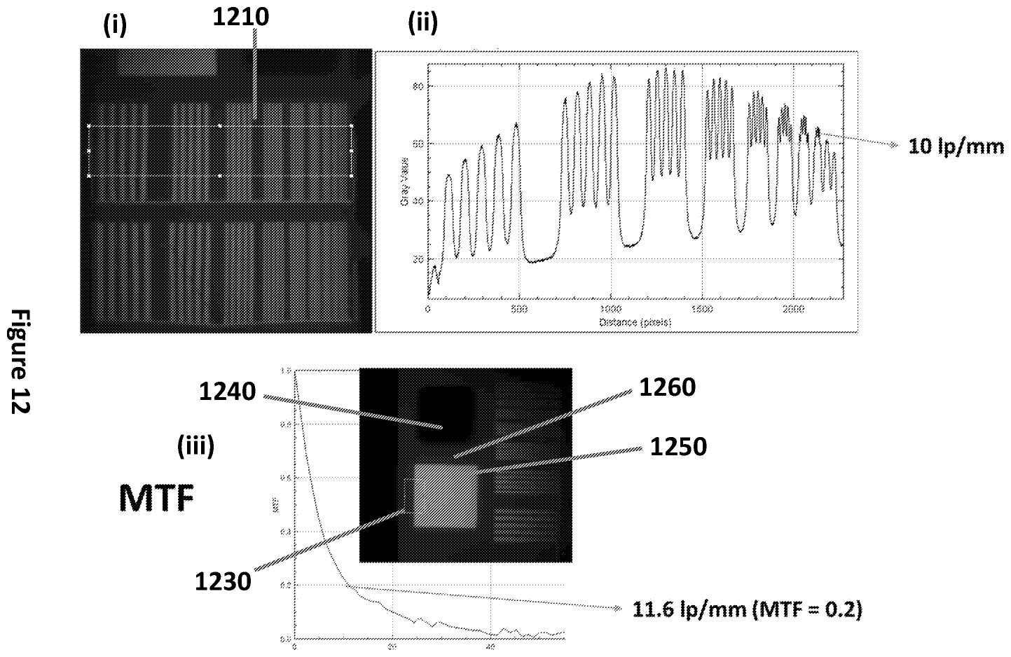

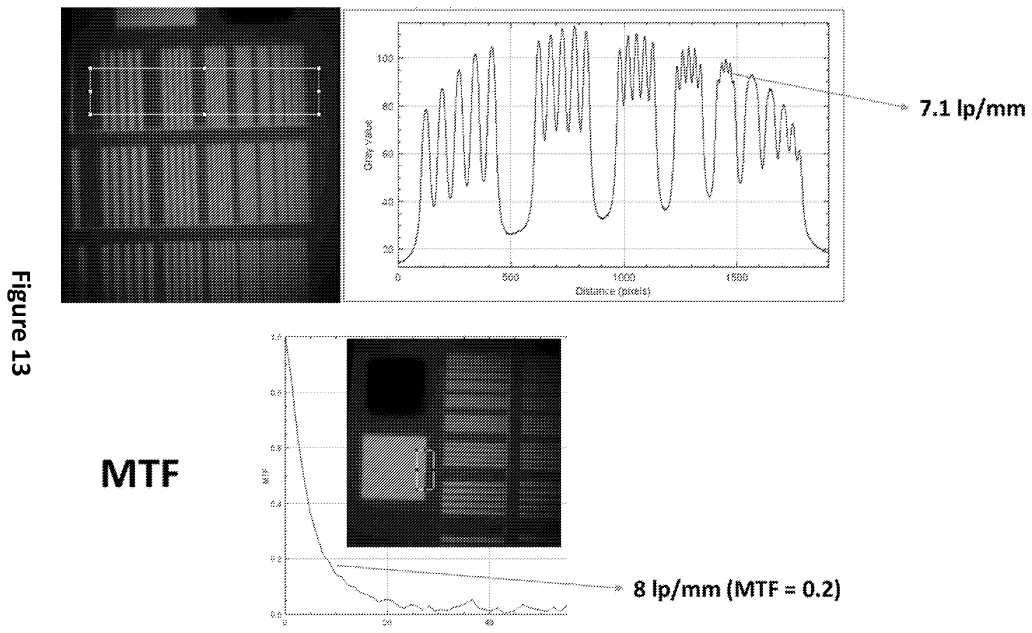

FIGS. 12 and 13 provide experimental data illustrating the performance of an X-ray scintillator film comprising Cs₃Cu₂I₅ microcrystals provided with various dopants in accordance with the present disclosure. The example of FIG. 12 is based on a film having a thickness of 100 μm while the example of FIG. 13 is based on a film having a thickness of 200 μm. The X-ray scintillator film may comprise a polymer film or any other suitable film.

Table 2 illustrates the light yield for an X-ray scintillator comprising a polymer film which contains doped Cs₃Cu₂I₅ microcrystals. In particular, a number of dopants were tested, namely Thallium (TI), Indium (In), Manganese (Mn), Terbium (Tb), Sodium (Na), Cerium (Ce) and Silver (Ag), a combination of Thallium and Indium (TI:In) and a combination of Thallium and Manganese (Ti:Mn). These results were obtained using a polymer film thickness of 100 μm.

TABLE 2

| Dopant | Tl | In | Mn | Tl:In | Tl:Mn | Tl:Tb | Tl:Na | Tl:Ce | Tl:Ag |
|---|---|---|---|---|---|---|---|---|---|
| Light yield | 16,600 | 10,000 | 8,000 | 28,000 | 17,000 | 15,000 | 16,000 | 9,500 | 10,000 |
| under X-ray | | | | | | | | | |
| source, | | | | | | | | | |
| photons/MeV | | | | | | | | | |
| Stability of | Stable | Stable | Stable | Stable | Stable | Stable | Turning | Turning | Turning |
| the powder | | | | | | | yellow | brown | yellow |
| | | | | | | | after storing | immediately | after storing |

It is clear from the results shown in Table 2 that a dopant based on the combination of TI: In provides a significantly better output light yield than the alternative dopants presented in Table 2, such as individual TI or In doping in terms of light yield. Accordingly, an X-ray scintillator based on nano or microcrystals of Cs₃Cu₂I₅ including a dopant based on the combination of Thallium and Indium appears to offer good sensitivity for detecting X-rays. A further increase in the light yield may potentially be obtained if the film is laminated with a reflector film from one side, for example, made of metal such as Al foil or silver film, etc.

A typical implementation of such an X-ray scintillator may (for example) utilise a TI: In molar ratio in the range 0.1 to 10 for the dopant, and a concentration of the dopant in the range 0.1 to 12% (by weight). Such an X-ray scintillator may (for example) have a film thickness in the range 10-500 μm (or 20-400 or 50-250 μm) and the polymer concentration in the film may be in the range 0-70% by weight (or 2-40% by weight). The results for assessing the spatial resolution of an X-ray scintillator as described above which includes a TI: In dopant are shown in FIGS. 12 and 13. In particular, FIG. 12 shows results for a polymer film thickness of 100 μm and FIG. 13 shows results for a polymer film thickness of 200 μm.

As discussed above in relation to FIG. 10, spatial resolution may be measured based on a set of striped line patterns. In the example of FIG. 10, each pattern comprises 3 parallel lines, whereas in FIGS. 12 and 13, each pattern comprises 5 parallel lines having a known, fixed spacing from one another. The patterns are arranged in a sequential order, such that the line width and spacing successively decrease from one pattern to the next. The limit of spatial resolution is reached when the imaging system is unable to discern (resolve) the separate lines within a given pattern. Rather, this pattern is detected as a solid (rather than striped) configuration.

The transition from a striped pattern to a solid pattern when progressing along the sequence of patterns may be formalised based on a MTF (modulation transfer function). MTF is scaled from one, when there is full resolution of the stripes in a given pattern, down to zero, when there is no resolution of the stripes in a given pattern. Therefore, the MTF value decreases as the sequence of patterns is assessed (in the direction of decreasing spacings). The spatial resolution of the imaging system can then be determined as the spacing of the last pattern (in the sequential ordering) to have an MTF value greater than a predefined threshold, say MTF=0.2

FIG. 12 is split into three portions denoted (i), (ii) and (iii). Image (i) illustrates a strip 1210 of consecutive patterns, each pattern comprising 5 parallel lines having the same width and spacing, and the width and spacing decreasing along the strip 1210. The lines in the pattern comprise X-ray scintillator material and so illuminate under exposure to X-rays. In practice, the X-ray scintillator material may be continuous, but with a mask (e.g. lead shield) applied to the incident X-rays as discussed above in relation to FIG. 10 to define the sequence of patterns as shown in image (i). An X-ray scintillator material comprising a polymer film of Cs₃Cu₂I₅ microcrystals doped with TI: In was used to obtain the spatial resolution results shown in FIGS. 12 and 13.

The image (ii) in FIG. 12 is a graph which has for the x axis the distance in pixels along the consecutive patterns corresponding to the strip 1210, and for the y axis the measured output luminosity (grayscale) from the X-ray scintillator. The image (ii) of FIG. 12 clearly shows a modulation pattern of five peaks (and intervening troughs) for the initial patterns in the strip 1210, with the patterns being separated from one another by deeper (larger) gaps (compared to the line spacings within individual patterns). The line spacing within the first six patterns is readily visible, but past this, for pixel 2000 and beyond, the separate patterns are still apparent, but it is much harder to discern the line spacings within a given pattern. Image (iii) is a graph which plots distance along the strip 1210 for the x axis and the calculated MTF value for the y axis. The x-axis has been calibrated to line pairs per millimetre. The spatial resolution is determined in image (iii) as 10-11.6 line pairs/mm based on a predetermined threshold of MTF 0.2. Note that if a lower MTF value is set for the threshold, such as 0.1 as adopted with respect to the results in FIG. 10, then the measured spatial resolution (the number of line pairs visible per mm) will increase. Conversely, if a higher MTF value (>0.2) is set for the threshold, then the measured spatial resolution will decrease. This outcome of 10-11.6 line pairs/mm compares favourably with the results discussed above in relation to FIG. 10. Thus the results for both FIG. 10 and FIG. 12 relate to doped X-ray scintillator comprising Cs₃Cu₂I₅ nano/micro-crystals. The FIG. 12 results involve the use of Thallium:Indium (TI:In) as the dopant and produced a spatial resolution of 10-11.6 line pairs/mm for MTF=0.2, whereas the FIG. 10 results involve the use of Thallium (TI) (without Indium) as the dopant and produced a lower spatial resolution of 3.5-4 line pairs/mm for a (less challenging) threshold of MTF=0.1.

FIG. 13 is likewise split into three portions (images) denoted (i), (ii) and (iii), matching those of FIG. 12. FIG. 13 is largely the same as FIG. 12, but the polymer film used for the X-ray scintillator is thicker-200 μm compared to 100 μm for FIG. 12. The spatial resolution is determined in image (iii) of FIG. 13 as 7.1-8 line pairs/mm for a threshold of MTF 0.2 (the same threshold as for FIG. 12). It will be appreciated that the results of FIG. 13 have a lower (less discriminating) spatial resolution compared with the results of FIG. 12. This may possibly be due to increased scattering and/or absorption in the thicker film used for the results of FIG. 13 compared with the thinner film used for the results of FIG. 12. Nevertheless, the spatial resolution of 7.1-8 Ip/mm for FIG. 13 is still better than the lower spatial resolution of 3.5-4 line pairs/mm for the results of FIG. 10 (which have MTF=0.1).

Accordingly, the use of TI: In as a dopant for a polymer film of Cs₃Cu₂I₅ microcrystals can lead not only to enhanced light output but also to better spatial resolution. (Improving light output will tend to help spatial resolution, other things being equal, because the greater light output generally enhances the signal-to-noise ratio for the image detector).

For completeness we comment briefly on two other aspects of FIGS. 12 and 13. In image (iii) there are two larger squares (shown to the left of the strip of patterns), one of which 1250 is illuminated and one of which is dark 1240. A yellow rectangle 1230 is shown which extends over the edge of the illuminated square. The values in this yellow rectangle can be used to assess the sharpness of the transition between illuminated and dark (masked) portions, which may be used to obtain additional information regarding the spatial resolution of the overall imaging system. In addition, the dark square is near to the illuminated square, with a bridge or bar 1260 between them which is very slightly illuminated. If the black square is artificially set to zero, the level of illumination in the bridge or bar may be used to assess the dark current level within the detector.

In conclusion, while various implementations and examples have been described herein, they are provided by way of illustration, and many potential modifications will be apparent to the skilled person having regard to the specifics of any given implementation. Accordingly, the scope of the present case should be determined from the appended claims and their equivalents. Furthermore, unless the context clearly indicates to the contrary, it is specifically disclosed herein that the features of any independent claim and/or its associated dependent claims may be combined with the features of any other independent claim and/or its associated dependent claims (irrespective of whether such a combination is explicitly claimed, since the claims are used to determine the scope of protection, not the overall disclosure of the application).

1. An X-ray scintillator comprising doped halide perovskite micro-crystals comprising Cs₃Cu₂I₅, wherein the doped halide perovskite micro-crystals are lead-free.

2-11. (canceled)

12. The X-ray scintillator of claim 1, wherein the doped halide perovskite micro-crystals are deposited onto or embedded into a polymer or plastic sheet.

13. (canceled)

14. The X-ray scintillator of claim 1, wherein the X-ray scintillator is flexible.

15. The X-ray scintillator of claim 14, wherein the X-ray scintillator is configured to have a radius of curvature less than 1 m, less than 0.50 m, less than 0.3 m, less than 0.15 m, less than 0.1 m, or less than 0.05 m.

16. The X-ray scintillator of claim 1 further comprising a planar film having a structured pattern of pores extending perpendicularly to the plane of the film, the pores being filled with micro-crystals to provide X-ray scintillation.

17. The X-ray scintillator of claim 16, wherein the pores are configured to tessellate across the plane of the film.

18. The X-ray scintillator of claim 17, wherein the pores are configured as regular hexagons, squares or rectangles.

19. (canceled)

20. The X-ray scintillator of claim 16, wherein the width of the pores is in the range 5 μm to 1 mm.

21. The X-ray scintillator of claim 16, wherein the average size of the micro-crystals is in the range.

22-27. (canceled)

28. The X-ray scintillator of claim 1, wherein the micro-crystals are doped with thallium (Th) or with the combination of thallium and indium (TI:In).

29. The X-ray scintillator of claim 28, wherein the TI:In molar ratio is in the range 0.1 to 10.

30-33. (canceled)

34. The X-ray scintillator of claim 1, wherein the X-ray scintillator comprises a film.

35. (canceled)

36. The X-ray scintillator of claim 34, wherein the thickness of the film is in the range 10 to 300 μm.

37. The X-ray scintillator of claim 34, wherein one side of the film is laminated with a reflector.

38. An X-ray scintillation detector comprising the X-ray scintillator of claim 1 in combination with a photodetector which is configured to convert light output from the X-ray scintillator into a digital electronic image.

39-68. (canceled)

69. A method of forming an X-ray scintillator comprising:
forming a film including a structured pattern of pores extending perpendicularly to the plane of the film; and
filling the pores with two or more precursor reactants for forming an X-ray scintillation material; and.
heating the pores filled with the precursor reactants so that they undergo a chemical reaction to form a single crystal of the X-ray scintillation material in each pore.

70. The method of claim 69, further comprising mixing the two or more precursor reactants prior to filling into the pores.

71. The method of claim 69, wherein the heating is performed to a temperature between 400-600° centigrade.

72. The X-ray scintillator of claim 34, wherein the reflector comprises a metal such as an aluminium foil or a silver film.

73. The method of claim 69, wherein the heating is performed for a duration in the range of 3-12 hours.
